(19) United States
(12) Patent Application Publication
(10) Pub. No.: US 2024/0272762 A1
(43) Pub. Date: Aug. 15, 2024

(54) PREDICTIVE RETRIEVAL OF CONTENT BASED ON CURSOR TRAJECTORY

(71) Applicant: Google LLC, Mountain View, CA (US)

(72) Inventor: Dongeek Shin, San Jose, CA (US)

(21) Appl. No.: 18/108,365

(22) Filed: Feb. 10, 2023

(51) Int. Cl. G06F 3/04812; G06F 3/04842; G06F 9/451; G06F 16/44

(52) U.S. Cl. CPC G06F 3/04812; G06F 3/04842; G06F 9/451; G06F 16/44

(57) ABSTRACT

A method includes presenting, on a screen of a client device of a user, a primary media item being viewed by the user and a representation of a secondary media item. The method further includes, while the primary media item is being viewed by the user and prior to a user selection of the secondary media item, predicting a user interest in viewing the secondary media item based on a trajectory of a cursor on the screen of the client device and causing a portion of the secondary media item to be pre-loaded to the client device. The method further includes, in response to the user selection of the secondary media item, initiating playback of the secondary media item using the pre-loaded portion of the secondary media item.

### TECHNICAL FIELD

Aspects and implementations of the present disclosure relate to content sharing platforms, and more specifically to predictively retrieving content to reduce load times.

### BACKGROUND

A platform (e.g., a content sharing platform) can transmit (e.g., stream) media items to client devices connected to the platform via a network. A client device may submit a request to the platform to transmit a certain media item.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

Systems and method are disclosed for predictively retrieving content. In some implementations, a method includes presenting, on a screen of a client device of a user, a primary media item being viewed by the user and a representation of a secondary media item. The method further includes, while the primary media item is being viewed by the user and prior to a user selection of the secondary media item, predicting a user interest in viewing the secondary media item based on a trajectory of a cursor on the screen of the client device and causing a portion of the secondary media item to be pre-loaded to the client device. The method further includes, in response to the user selection of the secondary media item, initiating playback of the secondary media item using the pre-loaded portion of the secondary media item.

In some embodiments, predicting the user interest in viewing the secondary media item based on the trajectory of the cursor on the screen of the client device includes obtaining a plurality of cursor positions. The method may further include identifying an area corresponding to the representation of the secondary media item. The method may further include extrapolating, based on the plurality of cursor positions, a future cursor position relative to the area corresponding to the representation of the secondary media item.

In some embodiments, predicting the user interest in viewing the secondary media item based on the trajectory of the cursor on the screen of the client device further includes determining whether the future cursor position overlaps the area corresponding to the representation of the secondary media item.

In some embodiments, causing the portion of the secondary media item to be pre-loaded to the client device includes, responsive to the future cursor position overlapping the area corresponding to the representation of the secondary media item, transmitting a request to pre-load at least the portion of the secondary media item.

In some embodiments, extrapolating the future cursor position includes calculating a predicted cursor position based on the plurality of cursor positions using at least one of: a Kalman filter prediction system, a linear regression model, a kinematics model, or a trained machine learning model.

In some embodiments, obtaining the plurality of cursor positions includes storing, at a predetermined timing interval, a current position of the cursor on the screen, the current position comprising an x-offset and a y-offset relative to an origin of the screen.

In some embodiments, predicting the user interest in viewing the secondary media item is further based on a speed of the cursor exceeding a predetermined threshold. In some embodiments, predicting the user interest in viewing the secondary media item is performed responsive to a pre-load triggering event. In some embodiments, the pre-load triggering event is at least one of completing a playback of a threshold portion of the primary media item or detecting the cursor in a predefined region of the screen of the client device.

In another aspect, a computing system includes a memory and one or more processors, coupled to the memory, to present, on a screen of a client device of a user, a primary media item being viewed by the user and a representation of a secondary media item. The one or more processors are further to, while the primary media item is being viewed by the user and prior to a user selection of the secondary media item, predict a user interest in viewing the secondary media item based on a trajectory of a cursor on the screen of the client device and cause a portion of the secondary media item to be pre-loaded to the client device. The one or more processors are further to, in response to the user selection of the secondary media item, initiate playback of the secondary media item using the pre-loaded portion of the secondary media item.

In some embodiments, to predict a user interest in viewing the secondary media item based on a trajectory of the cursor on the screen of the client device, the one or more processors are further to obtain a plurality of cursor positions. The one or more processors may be further to identify an area corresponding to the representation of the secondary media item. The one or more processors may be further to extrapolate, based on the plurality of cursor positions, a future cursor position relative to the area corresponding to the representation of the secondary media item.

In some embodiments, to predict the user interest in viewing the secondary media item based on the trajectory of the cursor on the screen of the client device, the one or more processors are further to determine whether the future cursor position overlaps the area corresponding to the representation of the secondary media item.

In some embodiments, to cause the portion of the secondary media item to be pre-loaded to the client device, the one or more processors are further to, responsive to the future cursor position overlapping the area corresponding to the representation of the secondary media item, transmitting a request to pre-load at least the portion of the secondary media item.

In some embodiments, to extrapolate the future cursor position, the one or more processors are further to calculate a predicted cursor position based on the plurality of cursor positions using at least one of: a Kalman filter prediction system, a linear regression model, a kinematics model, or a trained machine learning model.

In some embodiments, to obtain the plurality of cursor positions, the one or more processors are further to store, at a predetermined timing interval, a current position of the cursor on the screen, the current position comprising an x-offset and a y-offset relative to an origin of the screen.

In some embodiments, to predict the user interest in viewing the secondary media item is further based on a speed of the cursor exceeding a predetermined threshold.

In another aspect, a non-transitory machine-readable storage medium stores instructions which, when executed, cause a processing device to perform operations including presenting, on a screen of a client device of a user, a primary media item being viewed by the user and a representation of a secondary media item. The operations further include, while the primary item is being viewed by the user and prior to a user selection of the secondary media item, predicting a user interest in viewing the secondary media item based on a trajectory of a cursor on the screen of the client device and causing a portion of the secondary media item to be pre-loaded to the client device. The operations further include, in response to the user selection of the secondary media item, initiating playback of the secondary media item using the pre-loaded portion of the secondary media item.

In some embodiments, predicting the user interest in viewing the secondary media item based on the trajectory of the cursor on the screen of the client device includes obtaining a plurality of cursor positions. The operations may further include identifying an area corresponding to the representation of the secondary media item. The operations may further include extrapolating, based on the plurality of cursor positions, a future cursor position relative to the area corresponding to the representation of the secondary media item.

In some embodiments, predicting the user interest in viewing the secondary media item based on the trajectory of the cursor on the screen of the client device further includes determining whether the future cursor position overlaps the area corresponding to the representation of the secondary media item.

In some embodiments, causing the portion of the secondary media item to be pre-loaded to the client device includes, responsive to the future cursor position overlapping the area corresponding to the representation of the secondary media item, transmitting a request to pre-load at least the portion of the secondary media item.

Optional features of one aspect may be combined with other aspects where appropriate.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture for predictive content retrieval, according to some embodiments.

FIGS. 2A-B illustrate example interfaces for predictive content retrieval, according to some embodiments.

FIG. 3 is a flow diagram of a method for predictive content retrieval, according to some embodiments.

FIG. 4 is a block diagram illustrating a computer system, according to some embodiments.

### DETAILED DESCRIPTION

Aspects and implementations of the present disclosure relate to predictively retrieving content of a content sharing platform to reduce or eliminate visibly-detectable load times. A platform (e.g., a content sharing platform, etc.) may have a remote server where media items are hosted and a corresponding local client (e.g., website application, smartphone application, computer program, or the like) that enables a user to interact with the remote server. The platform can enable a user to access a media item (e.g., a video item, an audio item, a document, a presentation, etc.) hosted by the platform (e.g., via a client device connected to the platform). The platform can provide a client device of a user executing the platform application with access to a primary media item (e.g., by transmitting the media item to the client device of the user, etc.) via a network (e.g., the Internet). The platform can also provide representations of secondary media items (e.g., recommended media items) to the client device of a user. The secondary media items may be similar or related to the primary media item being accessed by the platform application on the client device. The representations (e.g., thumbnails, animated images, etc.) of the secondary media items may be visible near the primary media item being accessed by the client device. By interacting with (e.g., clicking on with an input device, hovering over with a cursor of an input device, etc.) the representation of a secondary media item, an access request for the secondary media item (e.g., for a file of a video item or a file of an audio item) may be sent by the platform application on the client device to the remote platform server. The remote platform server may provide the client device of the user with access to the secondary media item (e.g., by transmitting the secondary media item to the client device of the user) subsequent to receiving the access request. There is a delay between submitting the access request from the client device and receiving the data related to the requested media item on the client device. The delay may be large if the client device has a slow network connection to the platform. During the delay, no media item may be displayed to the user in the platform application on the client device, resulting in a negative user experience.

To reduce (or eliminate) the amount of delay time (e.g., when no media item is being displayed to the user) in the platform application on the client device, the access request can be sent to the remote platform server before the user interacts with the representation of a secondary media item in the platform application on the client device. One possibility is to download a portion (e.g., the first 2 seconds) of every secondary media item that is visible to the user within the platform application on the client device. However, this will result in requesting and downloading data for many media items the user does not intend to watch at that time (“false positives”). Too many false positives can result in poor utilization of limited resources of the client device (e.g., network bandwidth).

Aspects of the present disclosure address the above and other deficiencies by predicting which secondary media item a user will (or is likely to) interact with and request that secondary media item before the user interaction occurs. In some embodiments, the platform application may predict which secondary media item a user will interact with based on a trajectory of a cursor of the client device in a graphical user interface (GUI) of the platform application. The cursor may be controlled with an input device of the client device (e.g., a mouse, a trackpad, a joystick, a trackball, etc.). The platform application may predict where the cursor will be in the GUI in a predetermined future amount of time (e.g., in 500 milliseconds from the time of the prediction operation). If the predicted position of the cursor overlaps with an area corresponding to a representation (e.g., thumbnail, animated image, title, address, etc.) of a secondary media item in the GUI, the platform application may submit an access request to the remote platform server for the secondary media item (e.g., a file of a secondary video item or a file of a secondary audio item) before the user selects the secondary media item (e.g., by clicking the cursor on its representation). An area corresponding to a representation of a secondary media item can be a GUI area that covers the representation of the secondary media item and that, when interacted with via the cursor, causes a user selection of the secondary media item to be recorded or otherwise identified. In some embodiments, such a GUI area is an invisible box-like area that is referred to herein as a hitbox.

A false positive may occur if the platform application submits an access request (e.g., download request) for a secondary media item visible in the GUI to the remote platform server and the user does not subsequently interact with (e.g., click on) the secondary media item. By submitting access requests only after a predicted position of the cursor overlaps with a GUI area corresponding to a representation of a secondary media item, fewer false positives can be achieved as compared to submitting download requests for all visible secondary media items.

By beginning a download of a secondary media item before the secondary media item is selected (e.g., clicked on), a first portion (e.g., the first 2 seconds) of the secondary media item may be available for display within the platform application GUI immediately upon clicking on the secondary media item. During playback of the first portion of the secondary media item, subsequent portions of the secondary media item can be downloaded from the remote platform server and buffered in the platform application on the user device, leading to an uninterrupted media experience for the user.

In some embodiments, the platform application on the client device may record the current position of a cursor of the client device at a predetermined interval (e.g., every 100 milliseconds). The current position of the cursor may include an x-offset and a y-offset relative to an origin of a screen of the client device. The origin may correspond to a predetermined position (e.g., X, Y coordinates) (0,0) of the screen. The origin may be in the top left corner of the screen, the middle of the screen, or any other suitable position. In some embodiments, the current position of the cursor may include an x-offset and a y-offset relative to an origin (position (0,0) of a platform application GUI, which can be predetermined for the platform application and can be different than the origin of the screen. The platform application may store in a memory of the client device a number (e.g., 5, 15, 30) of most recent cursor positions. For example, the cursor positions may be stored such that older cursor positions are replaced when newer cursor positions are added. Based on the stored cursor positions, the platform application may extrapolate a future cursor position. In some embodiments, the platform application may extrapolate a future cursor position prediction using a Kalman filter prediction system. In some embodiments, the platform application may predict a future cursor position using a linear regression model and/or a kinematics model. In some embodiments, the platform application may predict a future cursor position using a trained machine learning model. For example, the trained machine learning model may, given a set of input cursor positions, output a cursor position that is most likely to occur at the next timing interval. The machine learning model may be trained using, for example, prior sequences of input cursor positions as training data. In some embodiments, the platform application may send current cursor positions to the remote platform server at the predetermined interval. The remote platform server may extrapolate a future cursor position of the cursor on the client device, and may, responsive to the future cursor position corresponding to a secondary media item hitbox on the client device, begin transmitting a first portion of the secondary media item to the platform application on the client device without the platform application sending an access request.

In some embodiments, after receiving a cursor position prediction, the platform application may compare the cursor position prediction to a hitbox of each representation of a secondary media item visible to the user in the platform application GUI on the user device. For example, each secondary media item hitbox may have a set of X,Y coordinates that correspond to corners of the boundaries of the hitbox. In some embodiments, a secondary media item hitbox may have an origin X,Y coordinate and a hitbox width and a hitbox height that can be used to calculate the boundaries of the hitbox. In some embodiments, a hitbox may have a top-left X,Y coordinate and a bottom-right X,Y coordinate that can be used to calculate the boundaries of the hitbox. The platform application may compare X,Y coordinates of the cursor position prediction to the boundaries of hitboxes of the representations of secondary media items visible to the user in the GUI. If the X,Y coordinates of the cursor position prediction are within the boundaries of a secondary media item hitbox, the platform application may send an access request (e.g., a request to download) for the secondary media item to the remote platform server. In some embodiments, the platform application may only send an access request for the secondary media item if the cursor position prediction is within the boundaries of the secondary media item hitbox and a calculated speed (e.g., change in position over time) of the cursor exceeds a predetermined threshold.

In some embodiments, the platform application on the client device may only record current cursor positions and predict future cursor positions if a pre-load triggering event has occurred. For example, the platform application may only record and predict cursor positions when a playback of a threshold portion of the primary media item of the platform application is completed. The threshold portion may be based on a duration of time (e.g., 60 seconds, 120 seconds) or may be based on a percentage of the total duration of the media item (e.g., 50%, 80%, 90%). In some embodiments, the platform application may only record and predict cursor positions when the cursor is in a predefined region of the screen of the client device (e.g., top half, left half, top-right quarter, etc.).

The remote platform server may send a first portion of the requested secondary media item to the platform application in response to the access request. The platform application may store the first portion of the requested secondary media item in a storage of the client device of the user. If the user clicks (e.g., using the cursor controlled by an input device of the client device) within the secondary media item hitbox, the platform application may load the first portion of the requested secondary media item from the storage of the client device and provide (e.g., display, play, show, cause to appear) the requested secondary media item to the user. The platform application may then send a second access request to the remote platform server, requesting a subsequent portion of the requested secondary media item.

Aspects of the present disclosure may provide technical advantages over previous solutions. Aspects of the present disclosure may predictively request content of a content sharing platform. This may improve the experience of a user using a platform application to interact with the content sharing platform by reducing (or eliminating) the time when a media item is not displayed within the platform application. By requesting access to a media item based on trajectory information of a cursor, the platform application can better utilize the computing resources of a client device of a user and reduce an apparent latency of requesting a media item from a remote server.

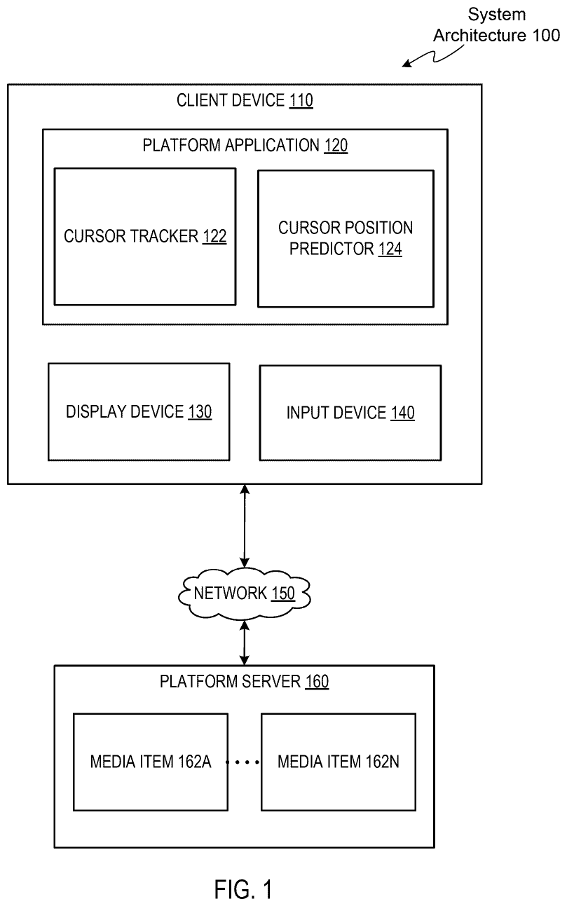

FIG. 1 illustrates an example system architecture 100 for predictive content retrieval, according to some embodiments. System architecture 100 includes client device 110, one or more networks 150, and platform server 160. Client device 110 includes platform application 120, display device 130, and input device 140. Display device 130 may be any device for showing a graphical output of a computing device, including a liquid crystal display (LCD) monitor, a light-emitting diode (LED) monitor, a projector, or the like. Display device 130 may include a screen with a cursor controlled by input device 140 that allows a user to interact with elements shown on the display. Input device 140 may be a mouse, a trackpad, a touchpad, a joystick, a trackball, or the like. Client device 110 may include one or more processors (not shown) capable of executing platform application 120. Platform application 120 may include computer instructions that, when executed by client device 110, allow client device 110 to interact with platform server 160. Platform application 120 may allow a user to interact with (e.g., watch, play, listen to, upload, download, etc.) media items hosted on platform server 160. Platform application 120 may include one or more components, such as cursor tracker 122 and cursor position predictor 124, used to predictively request media items from platform server 160. Platform application 120 of client device 110 may connect to platform server 160 via one or more networks 150. In some embodiments, while the platform application 120 presents a primary media item to a user, cursor tracker 122 records positions of the cursor on the screen of the client device 110, and cursor position predictor 124 predicts a user interest in viewing a secondary media item using a trajectory of the cursor on the screen of the client device, and causes a portion of the secondary media item to be pre-loaded to the client device based on the predicted user interest, as will be discussed in more detail below. In some embodiments, the primary media item may be a media item currently presented (e.g., and played) to the user by the platform application on the screen (e.g., a focus region of the screen) of the client device 110, and the secondary media item may be an ad or another media item similar or related to the primary media item and presented in a different region of the screen of the client device 110.

The one or more networks 150 may include one or more public networks (e.g., the Internet), one or more private networks (e.g., a local area network (LAN), a wide area network (WAN)), one or more wired networks (e.g., Ethernet network), one or more wireless networks (e.g., an 802.11 network), one or more cellular networks (e.g., a Long Term Evolution (LTE) network), routers, hubs, switches, server computers, and/or a combination thereof. Platform server 160 may include one or more computing devices (such as a rackmount server, a router computer, a server computer, a personal computer, a mainframe computer, a laptop computer, a tablet computer, a desktop computer, etc.) and one or more data stores (e.g., hard disks, memories, and databases) and may be coupled to the one or more networks 150.

Platform server 160 may include one or more servers and can enable users to consume, upload, share, search for, approve of (“like”), dislike, and/or comment on media items 162A-N (referred to generally as “media item 162” herein). Platform server 160 may include a website (e.g., a webpage) or application back-end software used to provide a user with access to media items (e.g., via client device 110). A media item can be consumed via the Internet or via a mobile application on the client device 110. A media item can correspond to a media file (e.g., a video file, an audio file, etc.) or a portion of a media file (e.g., a portion or a chunk of a video file, an audio file, etc.). As used herein, “media,” “media item,” “online media item,” “digital media,” “digital media item,” “content,” and “content item” can include an electronic file that can be executed or loaded using software, firmware, or hardware configured to present the digital media item to an entity. In some embodiments, media item 112 is a video item. A video item refers to a set of sequential video frames (e.g., image frames) representing a scene in motion. For example, a series of sequential video frames can be captures continuously or later reconstructed to produce animation. Video items can be provided in various formats including, but not limited to, analog, digital, two-dimensional and three-dimensional video. Further, video items can include movies, video clips, or any set of animated images to be displayed in sequence. In some embodiments, a video item can be stored as a video file that includes a video component and an audio component. The video component can include video data that corresponds to one or more sequential video frames of the video item. The audio component can include audio data that corresponds to the video data.

Platform server 160 may host one or more media items and may allow platform application 120 of client device 110 to access the one or more media items (e.g., by transmitting the media item to platform application 120). Platform application 120 may be part of platform server 160 or part of another system. Examples of media items may include, and are not limited to, digital video, digital movies, animated images, digital photos, digital music, digital audio, digital video games, collaborative media content presentations, website content, social media updates, electronic books, electronic journals, digital audio books, web blogs, software applications, documents, etc. Media items may also be referred to as content items. Media items may be pre-recorded or live-streamed. For brevity and simplicity, a video may be used as an example of a media item throughout this document. The video may include a pre-recorded video, a live-streamed video, a short-form video, etc.

In general, functions described in implementations as being performed by platform server 160 can also be performed on client device 110 in other implementations, if appropriate. In addition, the functionality attributed to a particular component can be performed by different or multiple components operating together. Platform server 160 can also be accessed as a service provided to other systems or devices through appropriate application programming interfaces (APIs), and thus is not limited to use in websites.

It should be noted that although some embodiments of the present disclosure are directed to a content sharing platform, embodiments of this disclosure can be applied to other types of platforms. For example, embodiments of the present disclosure can be applied to a content archive platform, a content storage platform, etc.

In implementations of the disclosure, a “user” or an “owner” can be represented as a single individual. However, other implementations of the disclosure encompass a “user” or an “owner” being an entity controlled by a set of users and/or an automated source. For example, a set of individual users or owners federated as a community in a social network can be considered a “user” or an “owner”. In another example, an automated consumer can be an automated ingestion pipeline, such as a topic channel, of the platform server 160.

In situations in which the systems discussed herein collect personal information about users (including owners), or can make use of personal information, the users can be provided with an opportunity to control whether the platform server 160 or platform application 120 collects user information (e.g., information about a user's social network, social actions or activities, profession, a user's preferences, or a user's current location), or to control whether and/or how to receive content from the content server that can be more relevant to the user. In addition, certain data can be treated in one or more ways before it is stored or used, so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by platform server 160 and/or platform application 120.

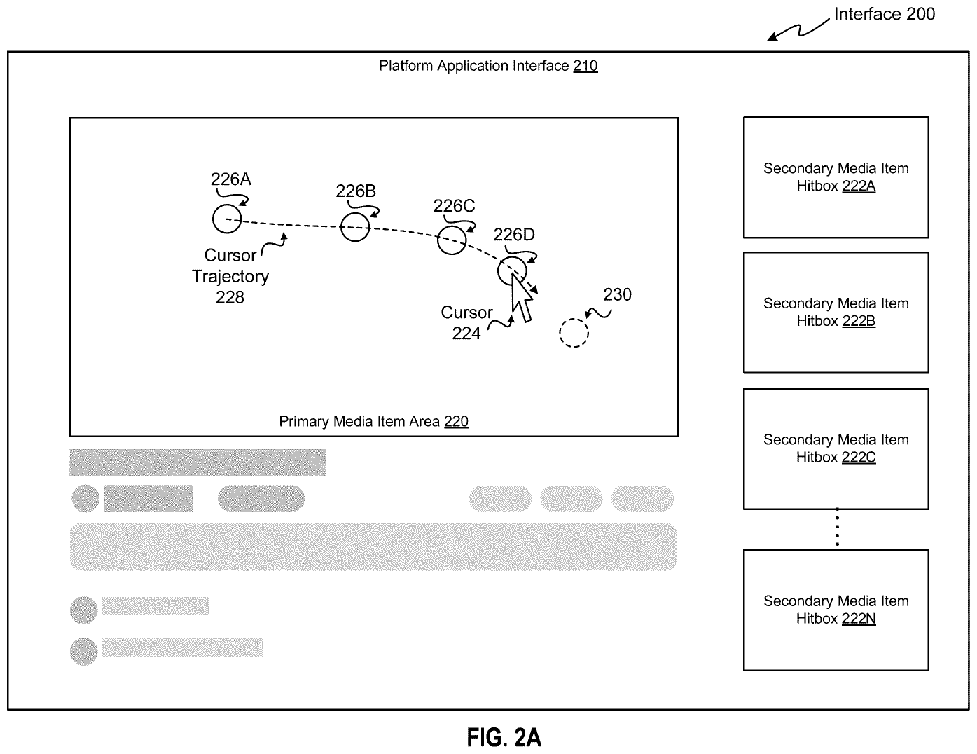

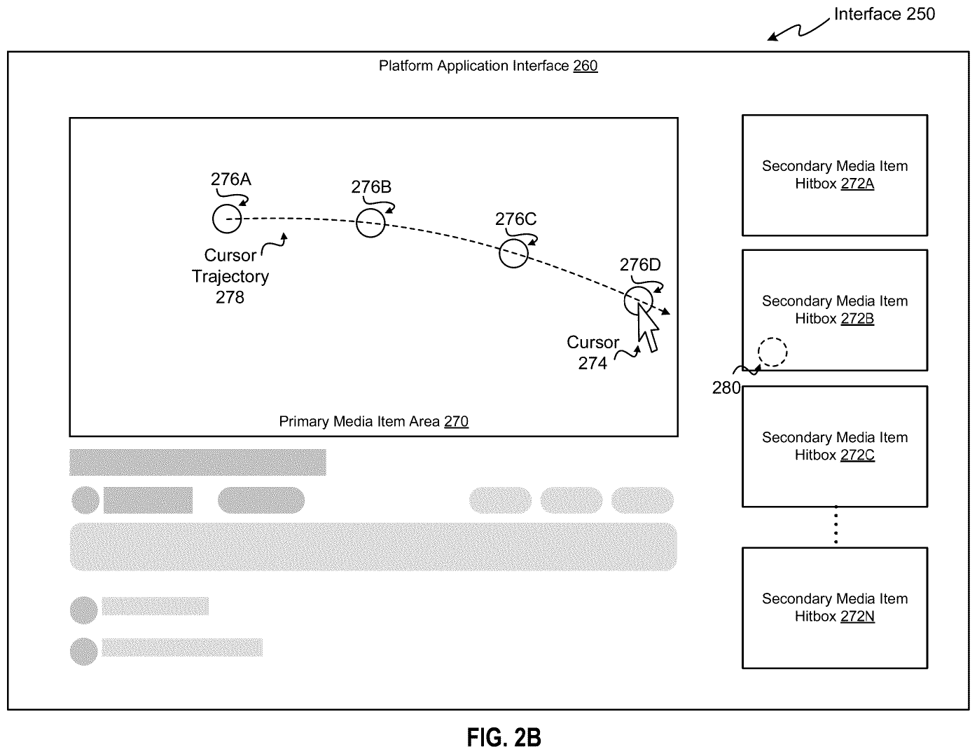

FIGS. 2A-B illustrate example interfaces for predictive content retrieval, according to some embodiments. FIGS. 2A-B may include graphical user interfaces (GUIs) provided by an application (e.g., platform application 120 of FIG. 1) of a client device. The application may be associated with/provided by a content platform (e.g., platform server 160 of FIG. 1) and may include a web browser application, a mobile application, a desktop application, or the like. User interaction with various elements of interfaces of FIGS. 2A-B may cause changes to the interface elements presented. Various interactions between the interfaces and interface elements presented in FIGS. 2A-B are possible (e.g., interacting with an element of a first UI layout may cause a transition to a second interface layout), and any transition between sample interfaces, similar interfaces, inclusion of similar interface elements, etc., are within the scope of this disclosure. FIGS. 2A-B are described in connection with video content items, but other types of content items (e.g., image content, text content, audio content, etc.) may be presented in similar interfaces.

FIG. 2A illustrates an example interface 200 for predictive content retrieval, according to some embodiments. Interface 200 may include platform application interface 210, which may include a primary media item area 220 and secondary media item hitboxes 222A-N. Primary media item area 220 may be a focus area for playback of a media item. For example, primary media item area 220 may be a video player and secondary media item hitboxes 222A-N may correspond to secondary video media items related to primary media item area 220. Secondary media item hitboxes 222A-N may each represent boundaries of an interaction region of platform application interface 210, where an interaction region can receive user input pertaining to a corresponding media item (e.g., clicking the cursor within the interaction region to request the corresponding media item from platform server 160 for viewing). Secondary media item hitboxes 222A-N may each contain one or more interface elements. For example, secondary media item hitboxes 222A-N may each include an image interface element depicting a representation (e.g., thumbnail image, animated image, etc.) of the corresponding media item and one or more text interface elements representing attributes of the corresponding media item (e.g., title, runtime, name of creator, etc.). In some embodiments, secondary media item hitboxes 222A-N may be hidden from the interface while the interface elements within the secondary media item hitboxes 222A-N (e.g., preview of media item, attributes of media item) may be visible.

Example interface 200 depicts stored cursor position indicators 226A-D, cursor trajectory 228, and predicted cursor position indicator 230 that may be hidden from the interface as displayed to a user. Example interface 200 depicts cursor 224 that may be controlled by an input device (e.g., mouse, trackpad, trackball, joystick, etc.) of a client device of a user executing platform application 120 of FIG. 1. As described above, platform application 120 may include cursor tracker 122 that may periodically store a position of cursor 224 in a memory of the client device. Stored cursor position indicator 226A-D may correspond to a position P of cursor 224 at intervals of time t (e.g., Pₜ₋₃, Pₜ₋₂, Pₜ₋₁, Pₜ). Predicted cursor position indicator 230 may correspond to a predicted position P of cursor 224 at time t+1 (e.g., Pₜ₊₁). Cursor trajectory 228 may be calculated based on the stored cursor positions. Platform application 120 may also include cursor position predictor 124. In some embodiments, cursor position predictor 124 may include a Kalman filter prediction system, a linear regression model, a kinematics model, a trained machine learning model, or any combination thereof. For example, a Kalman filter prediction system may be used to predict Pₜ₊₁ based on N stored cursor positions P₁₋ₙ₋₁ . . . Pₜ₋₂, Pₜ₋₁, Pₜ. The Kalman filter prediction system may be provided by platform application 120 and may be executed by a processor of the client device based on past cursor positions stored in a memory of the client device. Referring to interface 200, cursor position predictor 124 may predict that cursor 224 will be at predicted cursor position indicator 230 at time t+1. Because predicted cursor position indicator 230 does not overlap any secondary media item hitboxes 222A-N, in order to preserve computing resources of the client device, platform application 120 may not submit a download request to platform server 160.

FIG. 2B illustrates an example interface 250 for predictive content retrieval, according to some embodiments. Example interface 250 may include platform application interface 260, which may include a primary media item area 270 and secondary media item hitboxes 272A-N. Example interface 250 depicts stored cursor position indicators 276A-D, cursor trajectory 278, and predicted cursor position indicator 230 that may be hidden from the interface as displayed to a user. Example interface 250 depicts cursor 274 that may be controlled by an input device (e.g., mouse, trackpad, trackball, joystick, etc.) of a client device of a user executing platform application 120 of FIG. 1. As described above, platform application 120 may include cursor tracker 122 that may periodically store a position of cursor 274 in a memory of the client device. Stored cursor position indicator 276A-D may correspond to a position P of cursor 274 at intervals of time t (e.g., Pₜ₋₃, Pₜ₋₂, Pₜ₋₁, Pₜ). Predicted cursor position indicator 280 may correspond to a predicted position P of cursor 274 at time t+1 (e.g., P(+1). Cursor trajectory 278 may be calculated based on the stored cursor positions. Platform application 120 may also include cursor position predictor 124. Referring to interface 250, cursor position predictor 124 may predict that cursor 274 will be at predicted cursor position indicator 280 at time t+1. Because predicted cursor position indicator 280 overlaps secondary media item hitbox 222B, platform application 120 may perform predictive content retrieval. For example, platform application 120 may submit a download request to platform server 160 requesting access to the media item corresponding to secondary media item hitbox 222B. The download request may include a requested duration of the media item to download. For example, the download request may request the first 2 seconds of the media item from platform server 160. In some embodiments, a number of frames of the media item may be requested in the download request instead of a duration of time. Platform application 120 may store the data corresponding to the requested media item received in a response from platform server 160 in a memory of the client device. If a user of the client device subsequently clicks on secondary media item hitbox 222B (e.g., using the input device and cursor 274), platform application 120 may immediately load the data corresponding to the media item corresponding to secondary media item hitbox 222B from the memory of the client device into primary media item area 270 of interface 250. Because the data is being loaded from a memory of the client device instead of being requested over a network, playback of the media item can begin immediately, providing an improved user experience. After (or concurrently with) loading the data into primary media item area 270, platform application 120 may submit a download request to platform server 160 for the remaining data of the media item corresponding to secondary media item hitbox 222B.

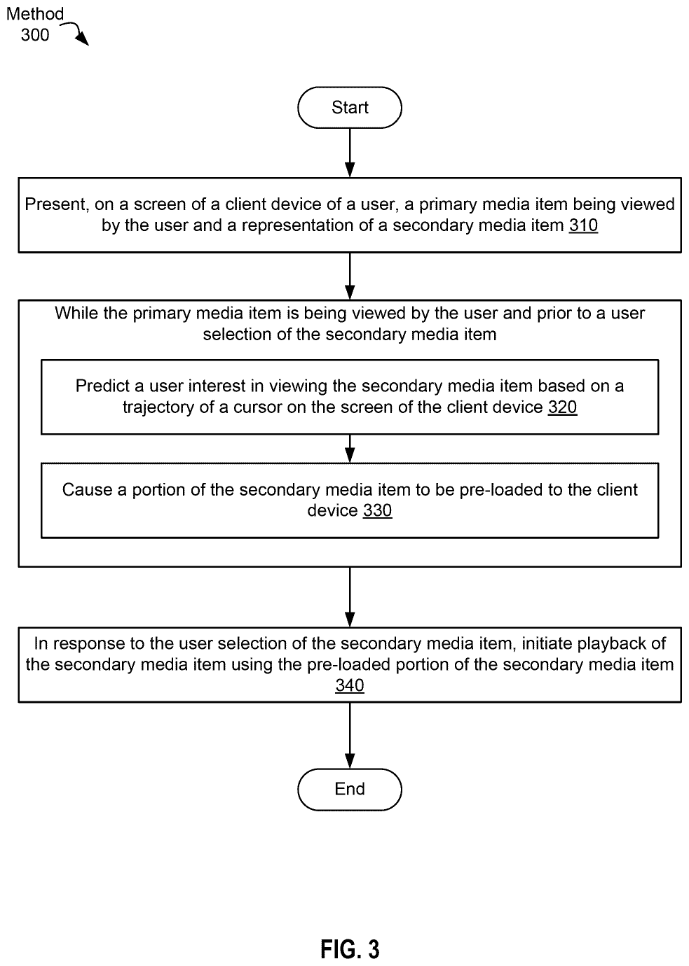

FIG. 3 is a flow diagram of a method 300 for predictive content retrieval, according to some embodiments. Method 300 may be performed by processing logic that may include hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiments, method 300 may be performed, in part, by platform server 160 and/or platform application 120 of FIG. 1. In some embodiments, a non-transitory machine-readable storage medium stores instructions that when executed by a processing device (e.g., of client device 110, of platform server 160, etc.) cause the processing device to perform method 300.

For simplicity of explanation, method 300 is depicted and described as a series of operations. However, operations in accordance with this disclosure can occur in various orders and/or concurrently and with other operations not presented and described herein. Furthermore, not all illustrated operations may be performed to implement method 300 in accordance with the disclosed subject matter. In addition, those skilled in the art will understand and appreciate that method 300 could alternatively be represented as a series of interrelated states via a state diagram or events.

In some embodiments, at block 310, the processing logic implementing method 300 may present, on a screen of a client device of a user, a primary media item being viewed by the user and a representation of a secondary media item. The primary media item being presented (e.g., and played) in a focus area on the screen of the client device, and the representation (e.g., a thumbnail, a preview, etc.) of the secondary media item may presented in a different area (e.g., below or above the focus area or to left or right of the focus area).

At block 320, processing logic may, while the primary media item is being viewed by the user and prior to a user selection of the secondary media item, predict a user interest in viewing the secondary media item based on a trajectory of a cursor on the screen of the client device. In some implementations, processing logic records, while the primary media item is being viewed, positions of the cursor on the screen of the client device that define the trajectory of the cursor. Processing logic can then predict the user interest in viewing the secondary media item by extrapolating, based on the trajectory of the cursor, a future cursor position relative to the area corresponding to the representation of the secondary media item (e.g., second media item hitbox 272), and determining whether the future cursor position overlaps (e.g., is within) the area corresponding to the representation of the secondary media item (e.g., second media item hitbox 272). If there is an overlap, then processing logic may decide that the user is interested in viewing (or playing) the secondary media item, and may proceed to blocks 330 and 340. Otherwise, processing logic may not perform blocks 330 and 340 during this session or until a user interest in viewing the secondary media item is detected.

At block 330, processing logic may, while the primary media item is being viewed by the user and prior to a user selection of the secondary media item, cause a portion of the secondary media item to be pre-loaded to the client device (e.g., by transmitting to a server a request to pre-load a portion of the secondary media item, receiving the pre-loaded portion from the server, and storing the pre-loaded portion locally). At block 340, in response to the user selection of the secondary media item, processing logic may initiate playback of the secondary media item using the pre-loaded portion of the secondary media item.

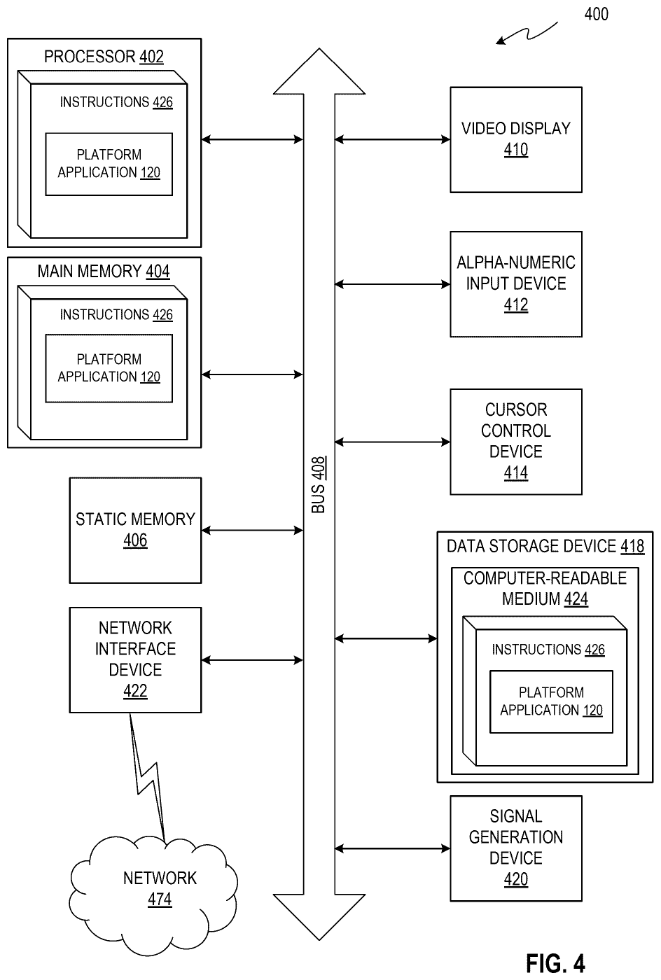

FIG. 4 is a block diagram illustrating a computer system 400, according to some embodiments. In some embodiments, computer system 400 may be connected (e.g., via a network, such as a Local Area Network (LAN), an intranet, an extranet, or the Internet) to other computer systems. Computer system 400 may operate in the capacity of a server or a client computer in a client-server environment, or as a peer computer in a peer-to-peer or distributed network environment. Computer system 400 may be provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 400 may include a processing device 402, a volatile memory 404 (e.g., Random Access Memory (RAM)), a non-volatile memory 406 (e.g., Read-Only Memory (ROM) or Electrically-Erasable Programmable ROM (EEPROM)), and a data storage device 418, which may communicate with each other via a bus 408.

Processing device 402 may be provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

Computer system 400 may further include a network interface device 422 (e.g., coupled to network 474). Computer system 400 also may include a video display unit 410 (e.g., an LCD), an alphanumeric input device 412 (e.g., a keyboard), a cursor control device 414 (e.g., a mouse), and a signal generation device 420.

In some embodiments, data storage device 418 may include a non-transitory computer-readable storage medium 424 (e.g., non-transitory machine-readable medium) on which may store instructions 426 encoding any one or more of the methods or functions described herein, including instructions encoding components of FIG. 1 (e.g., platform application 120) and for implementing methods described herein.

Instructions 426 may also reside, completely or partially, within volatile memory 404 and/or within processing device 402 during execution thereof by computer system 400, hence, volatile memory 404 and processing device 402 may also constitute machine-readable storage media.

While computer-readable storage medium 424 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving.” “performing.” “providing,” “obtaining,” “causing.” “accessing.” “determining,” “adding.” “using,” “training,” “reducing.” “generating,” “correcting,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may include a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and embodiments, it will be recognized that the present disclosure is not limited to the examples and embodiments described. The scope of the disclosure should be determined with reference to the following claims, along with the full scope of equivalents to which the claims are entitled.

Reference throughout this specification to “one implementation.” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics may be combined in any suitable manner in one or more implementations.

To the extent that the terms “includes,” “including,” “has.” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What is claimed is:

1. A method comprising:
presenting, on a screen of a client device of a user, a primary media item being viewed by the user and a representation of a secondary media item; and
while the primary media item is being viewed by the user and prior to a user selection of the secondary media item:
predicting a user interest in viewing the secondary media item based on a trajectory of a cursor on the screen of the client device, wherein predicting the user interest in viewing the secondary media item based on the trajectory of the cursor on the screen of the client device comprises extrapolating a future cursor position; and
causing a portion of the secondary media item to be pre-loaded to the client device; and
in response to the user selection of the secondary media item, initiating playback of the secondary media item using the pre-loaded portion of the secondary media item.

2. The method of claim 1, wherein predicting the user interest in viewing the secondary media item based on the trajectory of the cursor on the screen of the client device further comprises:
obtaining a plurality of cursor positions; and
identifying an area corresponding to the representation of the secondary media item; and
wherein extrapolating the future cursor position is based on the plurality of cursor positions, and wherein the future cursor position is relative to the area corresponding to the representation of the secondary media item.

3. The method of claim 2, wherein predicting the user interest in viewing the secondary media item based on the trajectory of the cursor on the screen of the client device further comprises:
determining whether the future cursor position overlaps the area corresponding to the representation of the secondary media item.

4. The method of claim 3, wherein causing the portion of the secondary media item to be pre-loaded to the client device comprises:
responsive to the future cursor position overlapping the area corresponding to the representation of the secondary media item, transmitting a request to pre-load at least the portion of the secondary media item.

5. The method of claim 2, wherein extrapolating the future cursor position comprises:
calculating a predicted cursor position based on the plurality of cursor positions using at least one of:
a Kalman filter prediction system,
a linear regression model,
a kinematics model, or
a trained machine learning model.

6. The method of claim 2, wherein obtaining the plurality of cursor positions comprises:
storing, at a predetermined timing interval, a current position of the cursor on the screen, the current position comprising an x-offset and a y-offset relative to an origin of the screen.

7. The method of claim 1, wherein predicting the user interest in viewing the secondary media item is further based on a speed of the cursor exceeding a predetermined threshold.

8. The method of claim 1, wherein predicting the user interest in viewing the secondary media item is performed responsive to a pre-load triggering event.

9. The method of claim 8, wherein the pre-load triggering event is at least one of completing playback of a threshold portion of the primary media item or detecting the cursor in a predefined region of the screen of the client device.

10. A computing system, comprising:
a memory; and
one or more processors, coupled to the memory, to:
present, on a screen of a client device of a user, a primary media item being viewed by the user and a representation of a secondary media item; and
while the primary media item is being viewed by the user and prior to a user selection of the secondary media item:
predict a user interest in viewing the secondary media item based on a trajectory of a cursor on the screen of the client device, wherein to predict the user interest in viewing the secondary media item based on the trajectory of the cursor on the screen of the client devices, the one or more processors are to extrapolate a future cursor position; and
cause a portion of the secondary media item to be pre-loaded to the client device; and
in response to the user selection of the secondary media item, initiate playback of the secondary media item using the pre-loaded portion of the secondary media item.

11. The system of claim 10, wherein to predict the user interest in viewing the secondary media item based on the trajectory of the cursor on the screen of the client device, the one or more processors are further to:
obtain a plurality of cursor positions; and
identify an area corresponding to the representation of the secondary media item; and
wherein the one or more processors are to extrapolate the future cursor position based on the plurality of cursor positions, and wherein the future cursor position is relative to the area corresponding to the representation of the secondary media item.

12. The system of claim 11, wherein to predict the user interest in viewing the secondary media item based on the trajectory of the cursor on the screen of the client device, the one or more processors are further to:
determine whether the future cursor position overlaps the area corresponding to the representation of the secondary media item.

13. The system of claim 12, wherein to cause the portion of the secondary media item to be pre-loaded to the client device, the one or more processors are further to:
responsive to the future cursor position overlapping the area corresponding to the representation of the secondary media item, transmitting a request to pre-load at least the portion of the secondary media item.

14. The system of claim 11, wherein to extrapolate the future cursor position, the one or more processors are further to:
calculate a predicted cursor position based on the plurality of cursor positions using at least one of:
a Kalman filter prediction system,
a linear regression model,
a kinematics model, or
a trained machine learning model.

15. The system of claim 11, wherein to obtain the plurality of cursor positions, the one or more processors are further to:
store, at a predetermined timing interval, a current position of the cursor on the screen, the current position comprising an x-offset and a y-offset relative to an origin of the screen.

16. The system of claim 10, wherein to predict the user interest in viewing the secondary media item is further based on a speed of the cursor exceeding a predetermined threshold.

17. A non-transitory computer-readable storage medium comprising instructions that, when executed by one or more processors, cause the one or more processors to perform operations comprising:
presenting, on a screen of a client device of a user, a primary media item being viewed by the user and a representation of a secondary media item; and
while the primary media item is being viewed by the user and prior to a user selection of the secondary media item:
predicting a user interest in viewing the secondary media item based on a trajectory of a cursor on the screen of the client device, wherein predicting the user interest in viewing the secondary media item based on the trajectory of the cursor on the screen of the client device comprises extrapolating a future cursor position; and
causing a portion of the secondary media item to be pre-loaded to the client device; and
in response to the user selection of the secondary media item, initiating playback of the secondary media item using the pre-loaded portion of the secondary media item.

18. The non-transitory computer-readable storage medium of claim 17, wherein predicting the user interest in viewing the secondary media item based on the trajectory of the cursor on the screen of the client device further comprises:
obtaining a plurality of cursor positions; and
identifying an area corresponding to the representation of the secondary media item; and
wherein extrapolating the future cursor position is based on the plurality of cursor positions, and wherein the future cursor position is relative to the area corresponding to the representation of the secondary media item.

19. The non-transitory computer-readable storage medium of claim 18, wherein predicting the user interest in viewing the secondary media item based on the trajectory of the cursor on the screen of the client device further comprises:
determining whether the future cursor position overlaps the area corresponding to the representation of the secondary media item.

20. The non-transitory computer-readable storage medium of claim 19, wherein causing the portion of the secondary media item to be pre-loaded to the client device comprises:
responsive to the future cursor position overlapping the area corresponding to the representation of the secondary media item, transmitting a request to pre-load at least the portion of the secondary media item.
